(19) United States
(12) Patent Application Publication
(10) Pub. No.: US 2012/0104673 A1
(43) Pub. Date: May 3, 2012

(54) STAGE APPARATUS FOR SURFACE PROCESSING

(75) Inventors: Yoshinori NAKANO, Kyoto-shi (JP); Satoshi MAYUMI, Kyoto-shi (JP); Kenichiro MIYASATO, Kyoto-shi (JP); Takashi YOSHIZAWA, Osaka-shi (JP); Yutaka MIYAJIMA, Osaka-shi (JP)

(73) Assignees: SHARP KABUSHIKI KAISHA, Osaka (JP); SEKISUI CHEMICAL CO., LTD., Osaka (JP)

(21) Appl. No.: 12/938,785

(22) Filed: Nov. 3, 2010

(51) Int. Cl. B23Q 3/00

(52) U.S. Cl. 269/14

(57) ABSTRACT

The present invention relates to a stage apparatus for placing a substrate to be surface-processed thereon. A substrate 9 is placed on a placing surface 22 of a stage 21. The substrate 9 is surface processed. After the surface processing, the substrate 9 is lifted by an up/down mechanism 30. During the lifting of the substrate, gas g2 is ejected from an ejection hole 46 of a nozzle 42 toward a gap between the substrate 9 and the placing surface 22. The ejection hole 46 is disposed outside of the placing surface 22 in plan view.

### BACKGROUND OF THE INVENTION

1. Field of the Invention

The present invention relates to a stage apparatus for placing a substrate to be surface-processed thereon.

2. Description of Related Art

Apparatus for placing substrates such as those made of glass for liquid crystal displays on a stage thereof for surface-processing the substrates are well known in the art (see International Publication No. WO2007/077765 (referred to as “Document 1” hereinafter), for example). Up/down pins and suction holes are provided in the stage. The up/down pins are protruded upward from the stage. A substrate is placed on the up/down pins by a manipulator. Then the up/down pins are lowered until the pins are retracted to inside the stage. By this operation, the substrate is placed on a top surface of the stage. Next, inside of the suction holes are suctioned, attracting and fixing the substrate to the stage. After that, processing gas is ejected from a processing gas supplier disposed above the stage. By being contacted with the processing gas, the substrate is surface processed, the surface processing including coating, surface modification (hydrophilization, hydrophobization, etc.), cleaning, etching and ashing.

After the surface processing is performed, inert gas is introduced to the suction holes, thereby releasing the suction between the substrate and the stage. Then, the up/down pins are protruded from the stage, thereby lifting the substrate with the up/down pins. After that, the substrate is changed using the manipulator.

In the lifting operation mentioned above, if the suction between the substrate and the stage is not sufficiently released or if peeling electrification occurs, local stress tends to be generated in the substrate. Especially when the number of the up/down pins is small, the local stress tends to be great, which may lead to breakage of the substrate.

In an apparatus of Japan Patent Application Publication H09-27538, ejection holes are provided in a central portion of a stage. When a substrate is lifted or lowered by the up/down pins, inert gas is ejected from the ejection holes and contacted with a central portion in an under surface of the substrate. By this arrangement, the substrate is prevented from bending.

### BRIEF SUMMARY OF THE INVENTION

The present invention relates to a stage apparatus for placing a substrate to be surface-processed thereon. The stage apparatus includes a stage having a placing surface, a first up/down mechanism and a nozzle having an ejection hole. The first up/down mechanism lowers the substrate from above the placing surface to the placing surface and lifts the substrate after the surface-processing from the placing surface. The ejection hole is disposed outside of the placing surface in plan view. The ejection hole opens toward an edge of the placing surface. When the substrate is lifted by the first up/down mechanism, gas is ejected from the ejection hole toward a gap between the substrate and the placing surface. The injection of the gas into the gap between the substrate and the placing surface from outside can assist in separation of the substrate from the placing surface. Even when peeling electrification occurs in the substrate, the portion of the substrate in which the peeling electrification occurs can be easily separated from the stage. Therefore, generation of local stress in the substrate can be prevented. Breaking of the substrate can be prevented.

Preferably, the ejection hole is gradually enlarged toward a distal end thereof in plan view. The gas from the ejection hole can be injected over a wide area between the substrate and the placing surface.

Preferably, at least one of an upper side of an inner surface of the ejection hole and a lower side of the inner surface of the ejection hole has a width along the edge of the placing surface. Preferably, at least one of the upper side of the inner surface of the ejection hole and the lower side of the inner surface of the ejection hole is inclined upward from outside of the placing surface in plan view and below the placing surface toward the distal end of the ejection hole. The gas is ejected along the inner surface in a plane gas flow. Therefore, the gas can surely enter the gap between the substrate and the placing surface.

Preferably, the nozzle is angle adjustable about an axis parallel to the edge of the placing surface. The gas from the nozzle can surely enter the gap between the substrate and the placing surface.

Preferably, the first up/down mechanism includes an outer periphery supporter that supports an outer peripheral portion of the substrate. The outer periphery supporter is arranged outside of the placing surface in plan view liftably and lowerably. The nozzle is disposed in the outer periphery supporter. The nozzle can be lifted and lowered together with the outer periphery supporter. The gas can be constantly blown out toward an under surface of the substrate while the substrate is being lifted and lowered. The substrate can be restrained or prevented from bending by its own weight. This can eliminate necessity of providing up/down pins as the up/down mechanism inside the stage. Or this can reduce the number of the up/down pins. When the number of the up/down pins is reduced, the substrate can be restrained or prevented from bending.

Preferably, the apparatus further includes a second up/down mechanism that lifts and lowers the nozzle in interlocked relation with the lifting and lowering of the substrate by the first up/down mechanism.

Preferably, the apparatus further includes an angle adjustment mechanism. The angle adjustment mechanism adjusts an angle of the nozzle about the axils parallel to the edge of the placing surface in interlocked relation with the lifting and lowering of the nozzle by the second up/down mechanism. The gas from the nozzle can surely enter the gap between the substrate and the placing surface. This allows the substrate to be surely separated from the placing surface.

Preferably, the apparatus includes a first and second nozzle members. The first and second nozzle members are spaced from each other in a direction along the edge of the placing surface. Each of the first and the second nozzle members constitutes the nozzle. The gas can be injected over a wide area between the substrate and the placing surface.

### BRIEF DESCRIPTION OF THE DRAWINGS

FIG. 1 is a front cross-sectional view of a surface processing apparatus according to a first embodiment of the present invention taken along line I-I of FIG. 2, the surface processing apparatus being in a surface processing step.

FIG. 2 is a plan view of a stage apparatus of the surface processing apparatus taken along line II-II of FIG. 1.

FIG. 3 is a front cross-sectional view of the surface processing apparatus in a receiving step or a removing step.

FIG. 4 is an enlarged front cross-sectional view of a region surrounding an outer end of a stage in an early stage of a lifting step.

FIG. 5 is an enlarged plan view of the region surrounding the outer end of the stage in the early stage of the lifting step.

FIG. 6 is a front cross-sectional view of a surface processing apparatus according to a second embodiment of the present invention taken along line VI-VI of FIG. 7, the surface processing apparatus being in a surface processing step.

FIG. 7 is a plan view of a stage apparatus of the surface processing apparatus according to the second embodiment taken along line VII-VII of FIG. 6.

FIG. 8 is a cross-sectional view of a periphery supporter of the surface processing apparatus according to the second embodiment taken along line VIII-VIII of FIG. 7.

FIG. 9 is a front cross-sectional view of the surface processing apparatus according to the second embodiment in a receiving step or a removing step.

FIG. 10 shows a nozzle according to the second embodiment and is a front cross-sectional view taken along line X-X of FIG. 11.

FIG. 11 is a cross-sectional plan view of the nozzle taken along line XI-XI of FIG. 10.

FIG. 12 is a plan view showing a third embodiment of the present invention.

FIG. 13(a) is a front cross-sectional view of a region surrounding an outer end of a stage in a surface processing step according to the third embodiment.

FIG. 13(b) is a front cross-sectional view of the region surrounding the outer end of the stage, with the region in an early stage of a lifting step according to the third embodiment being shown in solid lines and the region in a state before the lifting step shown in imaginary lines.

### DETAILED DESCRIPTION OF PREFERRED EMBODIMENTS

### First Embodiment

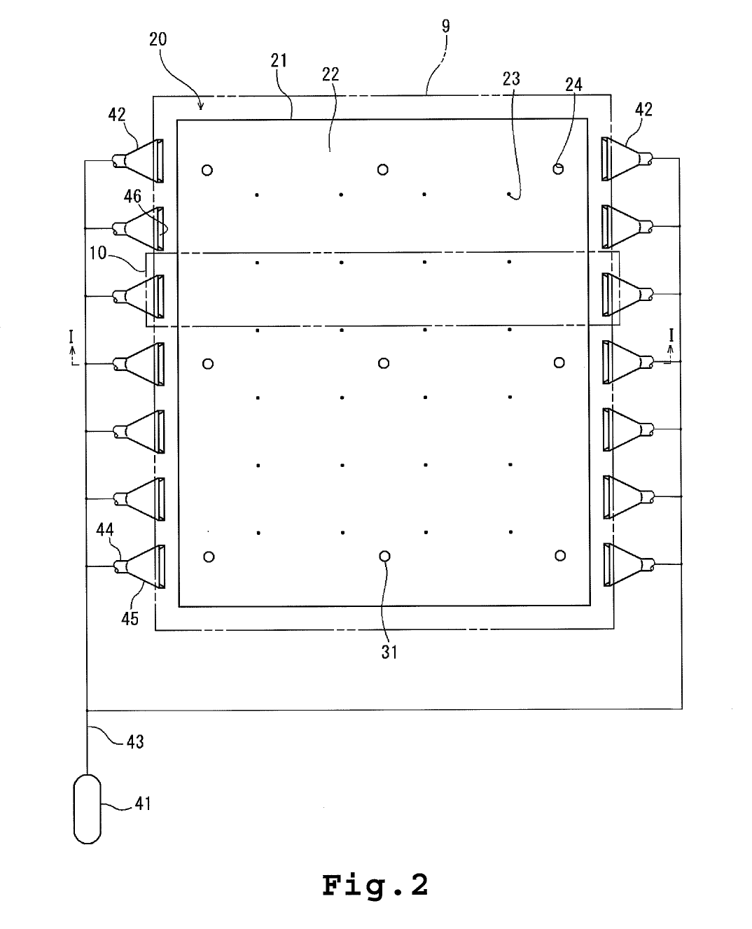

As shown in FIG. 2, a substrate 9 to be surface processed is a glass substrate for flat panel displays such as liquid crystal displays. The substrate 9 has a rectangular (quadrangular) thin plate configuration in plan view.

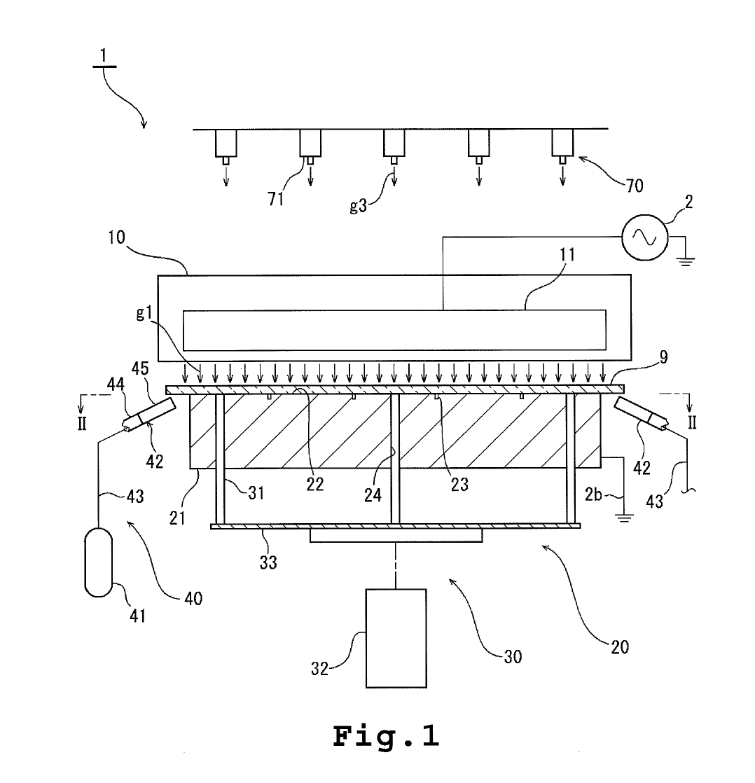

FIGS. 1 and 2 show an apparatus 1 for processing a surface of the substrate 9. The apparatus is not designed for any particular kinds of processing, and the apparatus can be used for various kinds of surface processing such as etching, ashing, surface modification (hydrophilization, hydrophobization, etc.), coating and sputtering. Although the surface processing apparatus 1 is presented as a normal pressure plasma processing apparatus for performing plasma processing under a generally atmospheric pressure, the surface processing apparatus 1 is not limited to this type of apparatus. The apparatus 1 may be a vacuum plasma processing apparatus for performing plasma processing under a low pressure. The apparatus 1 may be an apparatus for processing a surface of a substrate without using plasma.

The surface processing apparatus 1 includes a processing head 10 and a stage apparatus 20. The processing head 10 extends in a left-right direction. Though not shown in the drawings, a movement mechanism is connected to the processing head 10. The movement mechanism reciprocally moves the processing head 10 in a front-rear direction orthogonal to the plane of FIG. 1.

An electrode for applying electric fields 11 is received in the processing head 10. The electrode 11 extends in a longitudinal direction of the head 10. A power source 2 is connected to the electrode 11. The power source 2 may supply continuous wave high frequency voltage. Alternatively, the power source 2 may produce pulse waveform voltage.

Though not shown in the drawings, a processing gas ejection passage is provided inside the processing head 10. Processing gas g1 is supplied by a processing gas source. The processing gas ejection passage leads the processing gas g1 to spread evenly in the left-right direction. Moreover, the processing gas ejection passage blows out the spread processing gas g1 toward under the processing head 10.

Components of the processing gas may be selected according to the kind of surface processing. Examples of the components of the processing gas include nitrogen (N₂), oxygen (O₂), clean dry air (CDA), perfluorocarbon (PFC), and SF₆. Examples of the perfluorocarbon include CF₄, C₂F₆ and C₃F₈. The processing gas may be composed of only one of the gas components mentioned above. The processing gas may be a mixed gas composed of two or more of the gas components mentioned above. The gas components are not limited to those listed above.

The stage apparatus 20 includes a stage 21 disposed below the processing head 10 and a first up/down mechanism 30 built in the stage 21. The stage 21 is made of a metal plate having a rectangular (quadrangular) configuration in plan view. The stage 21 is electrically grounded via an earth wire 2b, thereby constituting a ground electrode.

Voltage is supplied by the power source 2 to the electrode 11. Electric fields are applied between the electrode 11 and the stage 21 as the ground electrode. Atmospheric pressure electrical discharge is generated between the electrode 11 and the stage 21. This causes the processing gas g1 from the processing head 10 to be plasmatized.

A top surface of the stage 21 constitutes a placing surface 22. As shown in FIG. 2, the placing surface 22 has a rectangular configuration with a longer side thereof oriented in the front-rear direction (top-bottom direction of FIG. 2) and a shorter side thereof oriented in the left-right direction. The substrate 9 is placed on the placing surface 22. The placing surface 22 is slightly smaller than the substrate 9. An outer peripheral portion of the substrate 9 protrudes outward from the placing surface 22.

A plurality of suction holes 23 are formed so as to be dispersively arranged in the placing surface 22. Although not shown in detail in the drawings, the suction holes 23 are selectively connected to a suction means and a pressurized gas source. The suction means includes a suction pump or a suction tank. The suction means suctions gas inside the suction holes 23. The pressurized gas source supplies pressurized first inert gas to the suction holes 23. The first inert gas may be rare gas such as helium and argon. The first inert gas may be nitrogen, oxygen, clean dry air (CDA), etc. The first inert gas may be mixed gas composed of two or more gases listed above.

A plurality of insertion holes 24 are formed so as to be dispersively arranged in the stage 21. The insertion holes 24 are formed vertically through the stage 21 from the top surface to an under surface thereof.

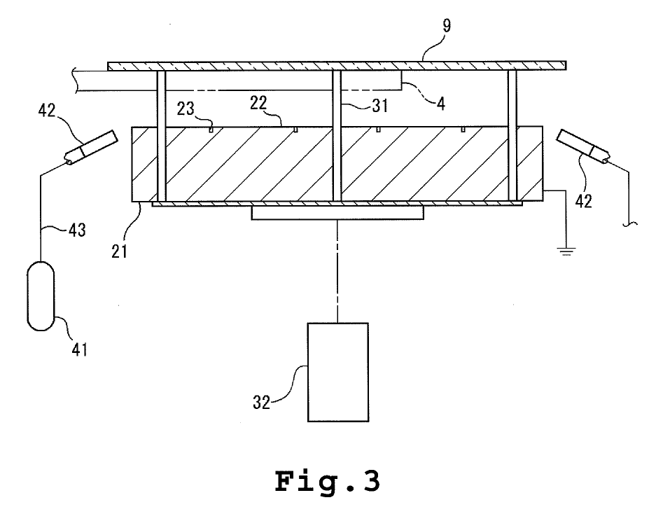

As shown in FIG. 1, an up/down mechanism 30 includes a plurality of up/down pins 31 and an up/down drive power source 32. Each of the up/down pins 31 is inserted in the insertion hole 24. Each of the up/down pins 31 extends out downward from the stage 21. A connecting board 33 connects lower end portions of the plurality of up/down pins. The up/down drive power source 32 is connected to the connecting board 33. The up/down drive power source 32 is constituted of a hydraulic actuator, etc. The up/down drive power source 32 lifts and lowers the up/down pins 31 between an up position (FIG. 3) and a down position (FIG. 1). As shown in FIG. 3, when in the up position, the up/down pins 31 are protruded upward from the stage 21. As shown in FIG. 1, when in the down position, the entire length of the up/down pins 31 are encased in the insertion holes 24.

Though not shown in the drawings, contact adjusters are provided with at least some of the plurality of the up/down pins 31 (see Document 1 given above). The contact adjusters are composed of elastic members such as coil springs interposed between the up/down pins 31 and the connecting board 33. Upper ends of the up/down pins 31 can be contacted with the under surface of the substrate 9 by adjusting the contact adjusters without lifting the substrate 9 on the placing surface 22.

As shown in FIGS. 1 and 2, the stage apparatus 20 further includes a mechanism 40 that ejects a gas from outside of the stage 21 for releasing the suction. The ejection mechanism 40 includes a gas source 41 for releasing the suction from outside and a plurality of external nozzles 42. A second inert gas, for example, is provided as the gas for releasing the suction from outside. The second inert gas is stored in a compressed state in the gas source 41. The second inert gas may be rare gas such as helium and argon. The second inert gas may be nitrogen, oxygen, clean dry air (CDA), etc. The second inert gas may be mixed gas composed of two or more gases listed above. One common gas source may be used both as the source of the gas from the suction holes 23 and the external gas source 41.

The external nozzles 42 are disposed in left and right sides of the stage 21. Each of the external nozzles 42 is located below the placing surface 22 and outside of edges of the longer (left and right) sides of the placing surface 22 in plan view. At each of the left and right sides of the stage 21, the plurality of external nozzles 42 are arranged along the edge of the longer side of the placing surface 22 spaced from each other. One of the plurality of external nozzles 42 in each of the left and right sides of the stage 21 constitutes a “first nozzle member” and another of the plurality of external nozzles 42 in each of the left and right sides of the stage 21 constitutes a “second nozzle member”.

Each of the external nozzles 42 has a cylindrical base portion 44 and a modified cylindrical ejection portion 45. As shown in FIG. 2, a release gas supply passage 43 extends from the release gas source 41. The supply passage 43 branches into plural ways. Each of the branch passages of the supply passage 43 continues to the base portion 44 of the corresponding nozzle 42.

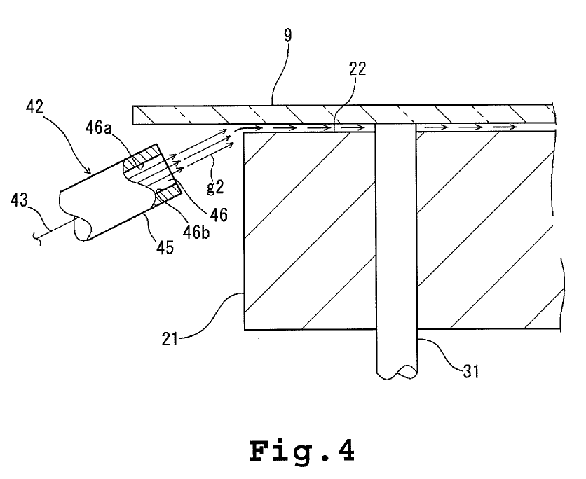

As shown in FIG. 1, the ejection portion 45 continues to a distal end of the base portion 44. The ejection portion 45 extends obliquely upward toward the edge of the longer side of the placing surface 22 from outside of the placing surface 22 in plan view. A distal end of the ejection portion 45 is disposed in a vicinity of the edge of the longer side of the placing surface 22. As shown in FIG. 2, the ejection portion 45 is shaped as a sector-shaped tube. An inner space of the ejection portion 45 constitutes an ejection hole 46. A width of the ejection hole 46 is gradually increased toward a distal end thereof in plan view. An opening at the distal end of the ejection hole 46 is shaped as a slit along the edge of the longer side of the placing surface 22. As shown in FIG. 4, an upper inner surface 46a and a lower inner surface 46b of the ejection hole 46 have a width along the edge of the longer side of the placing surface 22. The upper inner surface 46a and the lower inner surface 46b of the ejection hole 46 are inclined upward toward the distal end of the ejection portion 45 from outside of and below the placing surface 22 in plan view. Preferably, the external nozzle 42 is angle adjustable about the axis parallel to the edge of the placing surface 22. And preferably, inclination angles of the upper and lower inner surfaces 46a, 46b are angle adjustable with respect to a horizontal plane.

As shown in FIG. 1, the surface processing apparatus 1 further includes an ionizer 70. The ionizer 70 is disposed right above the stage 21 and at a height higher than the processing head 10. The ionizer 70 includes a plurality (five in FIG. 1) of ionizer nozzles 71. The ionizer nozzle 71 are oriented downward and arranged spaced from each other in the left-right direction. An electrode (not shown) for ionization is housed in the ionizer nozzle 71.

Nitrogen (N₂), for example, is used as gas to be ionized. The nitrogen gas is supplied to each of the ionizer nozzles 71. Each of the ionizer nozzles 71 ionizes the nitrogen gas. The ionized nitrogen gas g3 is blown out from the ionizer nozzles 71. The ionized gas g3 includes both positive ions and negative ions.

A method for processing the surface of the substrate 9 using the surface processing apparatus 1 having the features mentioned above will be described below.
(1) Receiving Step

As shown in FIG. 3, the up/down pins 31 are positioned in the up position. The substrate 9 to be surface processed is placed on the up/down pins 31 by a forked manipulator 4. At this time, the processing head 10 is retreated to a position where the processing head 10 will not interfere with the substrate 9 or the up/down pins 31.
(2) Setting Step

The forked manipulator 4 is retreated. After the retrieval, the up/down pins 31 are lowered to the down position as shown in FIG. 1. This makes the substrate 9 to be placed on the placing surface 22. Subsequently, the gas inside the suction holes 23 is sucked. The suction causes the substrate 9 to be attracted and fixed to the stage 21.
(3) Surface Processing Step

Next, while the processing head 10 is being reciprocated in the front-rear direction, the processing gas g1 is blown out toward the gap between the processing head 10 and the substrate 9. Electric fields are applied between the electrode 11 and the stage 21 by supplying voltage to the electrode 11 from the power source 2. This causes the processing gas g1 to be plasmatized. The plasmatized processing gas contacts the substrate 9, thereby processing the surface of the substrate 9.
(4) Releasing Step

After the surface processing, the processing head 10 is retreated outside of the stage 21. The inert gas is introduced to the suction holes 23. This releases the suction between the substrate 9 and the stage 21 in a periphery of the suction holes 23.

At the same time or before or after the introduction of the inert gas into the suction holes 23, the compressed inert gas from the release gas source 41 is introduced to each of the external nozzles 42 via the respective supply passages 43. Inert gas g2 is blown out obliquely upward from the ejection portion 45 of each of the external nozzles 42. The inert gas g2 is blown out toward a corner portion formed by an outer peripheral portion of an under surface of the substrate 9 and an outer end surface of the stage 21.
(5) Lifting Step

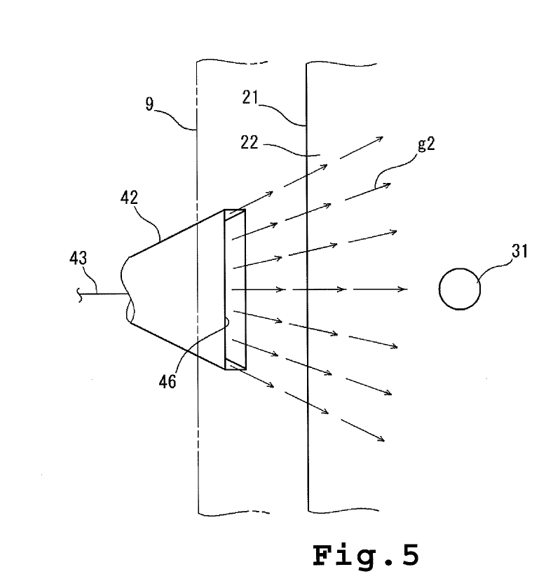

Subsequently, as shown in FIG. 4, the up/down pins 31 are lifted from the down position. At this time, the inert gas g2 from the external nozzles 42 enters the gap between the substrate 9 and the placing surface 22 from outside of the stage 21. As shown in FIG. 5, the inert gas g2 flows as a planar gas flow spreading in a sector shape due to the shape of the ejection hole 46. Therefore, even when the gap between the substrate 9 and the placing surface 22 is still narrow, the inert gas g2 can be injected sufficiently and over a wide area. The planar gas flow of the inert gas g2 can be surely injected between the substrate 9 and the placing surface 22 by adjusting an angle at which the external nozzles 42 are disposed and by adjusting the inclination angle of the upper and lower inner surfaces 46a, 46b of the ejection holes 46. The plurality of ejection portions 45 enables the inert gas g2 to be spread evenly almost throughout the space between the substrate 9 and the placing surface 22 in the longer side direction. Pressure of the inert gas g2 can help separate the substrate 9 upward from the placing surface 22. Even if the releasing of the suction between the substrate 9 and the placing surface 22 may not be sufficient only by the inert gas from the suction holes 23, the substrate 9 can be surely separated from the placing surface 22 by the inert gas g2 from the external nozzles 42. Even when the substrate 9 is adhered to the placing surface 22 by coulomb force due to peeling electrification, a portion of the substrate 9 in which the peeling electrification occurs can be easily separated. Accordingly, generation of local pressure can be prevented in the portion of the substrate 9 in which the peeling electrification occurs. Therefore, the substrate 9 can be prevented from being broken. As a result, the substrate 9 can be lifted easily from the placing surface 22.

Timing for starting the ejection of the inert gas g2 from the external nozzles 42 is not limited to the time before the start of the lifting of the up/down pins 31. The timing for starting the ejection of the inert gas g2 can be set concurrently or after the start of the lifting of the up/down pins 31. In this case, even if adherence between the substrate 9 and the stage 21 is weak, the substrate 9 can be prevented from sliding off the stage 21 by the inert gas g2 from the external nozzles 42.

It is preferable that lifting speed of the up/down pins 31 is set as low as possible until the substrate 9 is completely separated from the placing surface 22. It is preferable that the lifting speed of the up/down pins 31 is set at about 0.1 to 5 mm/second, for example. This can surely prevent the substrate 9 from being broken due to peeling electrification, etc. After the substrate 9 is completely lifted, the lifting speed of the up/down pins 31 can be set relatively high. It is preferable that the lifting speed of the up/down pins 31 is set at about 5 to 100 mm/second, for example. This can shorten the time needed for the lifting. By keeping the lifting speed at or below 100 mm/second, the substrate 9 can be prevented from being broken due to air pressure at the time of lifting.

When the substrate 9 is lifted to some degree, the ejection of the inert gas g2 from the external nozzles 42 is stopped.
(6) Removing Step

As shown in FIG. 3, after the substrate 9 is lifted to the up position, the substrate 9 on the up/down pins 31 is picked up by the forked manipulator 4. Then the substrate 9 is removed. After that, the steps (1) to (6) given above are repeated for another substrate 9.
(7) Ion Ejection Step

The ionizer 70 is kept ON all the time while the surface processing apparatus 1 is operating to continuously eject the ionized gas g3 from the ionizer nozzle 71. The amount of flow of the ionized gas g3 ejected from each of the ionizer nozzles 71 is about 50 slm, for example. Constant ejection of the ionized gas g3 causes the general entirety of the surface processing apparatus 1 to be surrounded by ion atmosphere. This allows for rapid removal of electrostatic charge even when peeling electrification occurs upon separation of the substrate 9 from the placing surface 22 in the Lifting Step mentioned above. Therefore, the substrate 9 can be more easily removed upward from the placing surface 22. Moreover, static electricity transmitted from the substrate 9 to the stage 21 can be prevented from being accumulated on the stage apparatus 20. Therefore, accumulation of electrostatic charge due to peeling electrification can be prevented when surface processing is continuously performed on a plurality of substrates 9.

Other embodiments of the present invention will now be described. In the drawings, the same reference numerals will be used to designate the same elements as the aforementioned embodiment and the description thereof will be omitted.

### Second Embodiment

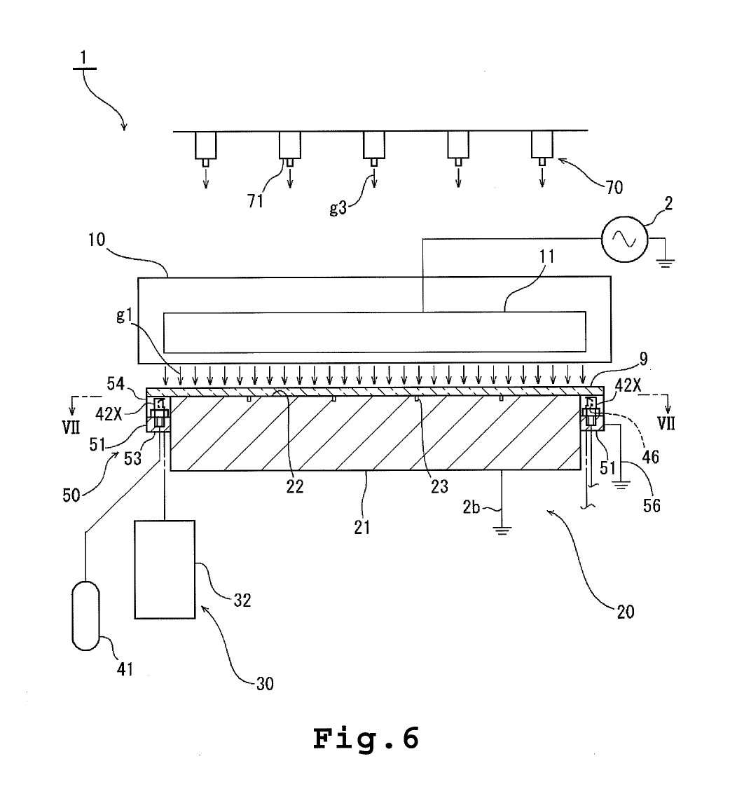

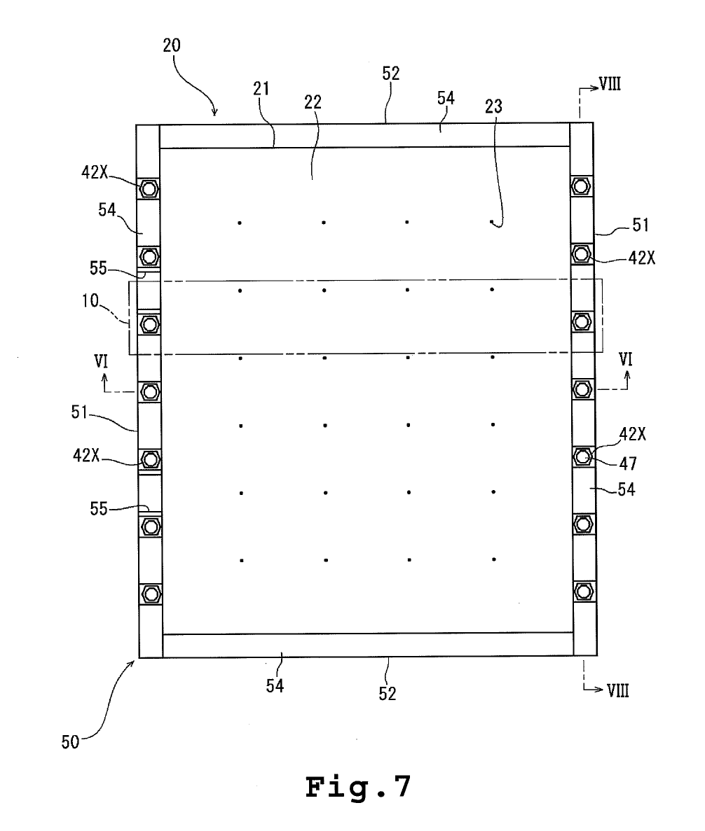

As shown in FIGS. 6 and 7, the stage 21 according to the second embodiment is not provided with the insertion holes 24 or the up/down pins 31. The up/down mechanism 30 includes an outer periphery supporter 50 instead of the up/down pins 31. As shown in FIG. 7, the outer periphery supporter 50 includes a pair of longer side support members 51 and a pair of shorter side support members 52. The longer side support members 51 and the shorter side support members 52 are disposed outside of the placing surface 22 in plan view. The longer side support members 51 extend along edges of longer sides (left and right) of the stage 21. The shorter side support members 52 extend along edges of shorter sides (front and rear) of the stage 21.

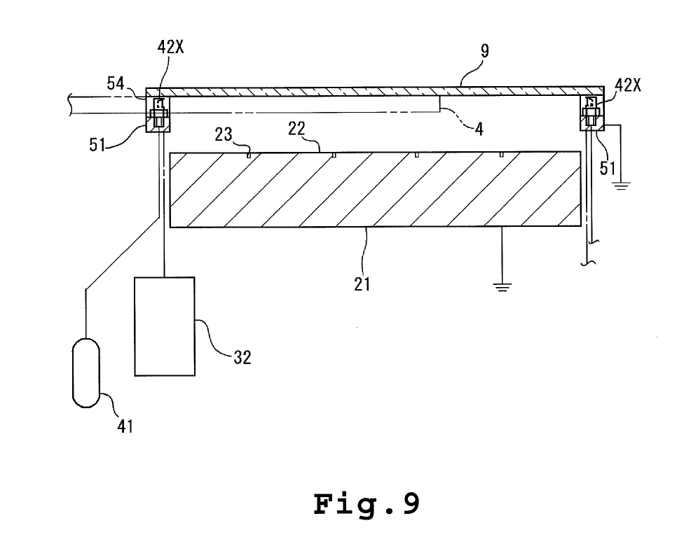

The outer periphery supporter 50 is lifted and lowered between an upper position (FIG. 9) and a down position (FIG. 6) by the up/down drive power source 32. As shown in FIG. 9, the outer periphery supporter 50 in the upper position is protruded above the stage 21. As shown in FIG. 6, a top surface of the outer periphery supporter 50 in the down position is coplanar with the placement surface 22. When in the down position, the top surface of the outer periphery supporter 50 may be located lower than the placement surface 22.

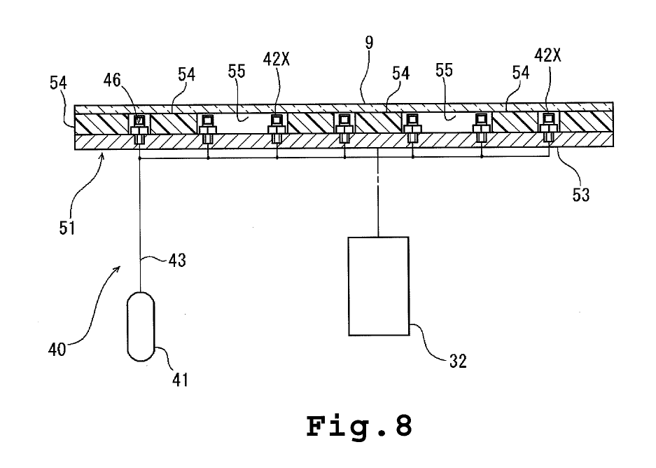

As shown in FIG. 8, each of the longer side support members 51 includes a beam 53 and a placing portion 54. The beam 53 is made of metal. The beam 53 extends horizontally along the edge of the stage 21. The placing portion 54 is provided on a top surface of the beam 53. The placing portion 54 is made of conductive plastics. The placing portion 54 is electrically grounded via the beam 53 made of metal and an earth wire 56. The outer peripheral portion of the substrate 9 is placed on a top surface of the placing portion 54.

Although not shown in detail in the drawings, each of the shorter side support members 52 includes the beam 53 and the placing portion 54 provided on the top surface of the beam 53 as with the longer side support members 51.

As shown in FIGS. 7 and 8, the support members 51 are provided with void portions 55. The placing portion 54 is not provided in the void portion 55. The forked manipulator is inserted in the void portion 55 when the outer periphery supporter 50 is in the upper position.

As shown in FIG. 6, the longer side support members 51 in the left and right are each provided with a plurality of external nozzles 42X. As shown in FIG. 7, the external nozzles 42X are arranged in a longitudinal direction of each of the longer side support members 51 spaced from each other. One of the plurality of the external nozzles 42X in each of the longer side support members 51 constitutes a “first nozzle member” and another of the plurality of the external nozzles 42X constitutes a “second nozzle member”. The placing portion 54 is not provided in a place where the external nozzle 42X is disposed.

As shown in FIG. 10, the external nozzle 42X has a roughly circular cylindrical configuration with an axis thereof oriented in the top-bottom direction. A lower side portion of the external nozzle 42X constitutes a base portion 44. An upper side portion of the external nozzle 42X constitutes the ejection portion 45. A screw portion 44b is formed on an outer peripheral surface of the base portion 44. The screw portion 44b is threaded in a female screw hole 53a formed in the beam 53.

An ejection guiding hole 44a is formed inside the base portion 44. The ejection guiding hole 44a extends vertically along the axis of the external nozzle 42X. A lower end portion of the ejection guiding hole 44a reaches a lower end surface of the external nozzle 42X, where the ejection guiding hole 44a opens to the outside. The supply passage 43 continues to the ejection guiding hole 44a. The ejection guiding hole 44a includes a tapered hole portion 44c, a diameter thereof being gradually reduced toward upward. A diameter of a portion of the ejection guiding hole 44a located above the tapered hole portion 44c is smaller than a diameter of a portion of the ejection guiding hole 44a located below the tapered hole portion 44c.

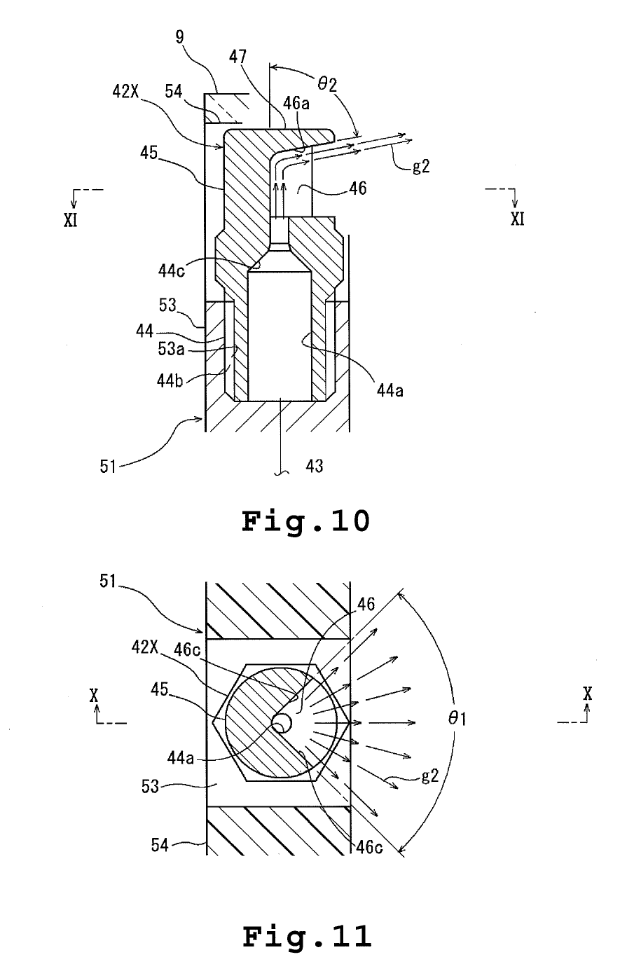

The ejection portion 45 of the external nozzle 42X is protruded higher than the beam 53. As shown in FIG. 11, the ejection portion 45 has a circular cylindrical configuration with one side of the ejection portion 45 in a circumferential direction cut out in a partially circular cylindrical configuration (having a sector-shaped cross-section). The cut-out portion of the ejection portion 45 having the partially circular cylindrical configuration constitutes the ejection hole 46. As shown in FIG. 6, the ejection hole 46 is open toward a side of the stage 21.

As shown in FIG. 11, a bottom surface of the ejection hole 46 has a configuration of a partial circle. An upper end portion of the ejection guiding hole 44a is open to a point to be a center of a partial circle constituting the bottom surface of the ejection hole 46.

The ejection hole 46 having the partially circular cylindrical configuration is gradually enlarged toward a distal end thereof in plan view (outer periphery of the external nozzle 42X). Preferably, an angle θ1 between opposite wall surfaces 46c, 46c of the ejection hole 46 is about from 100 to 150 degrees.

As shown in FIG. 10, a cap portion 47 is formed in an upper end portion of the external nozzle 42X. The cap portion 47 has a circular configuration in plan view (see FIG. 7). A one side portion of the cap portion 47 in a circumferential direction overhangs above an upper end portion of the ejection hole 46. An under surface of the cap portion 47 overhanging the ejection hole 46 defines the upper inner surface 46a of the ejection hole 46. The upper inner surface 46a is an inclined surface inclined upward toward the outer periphery of the cap portion 47. Preferably, an angle θ2 of the inner surface 46a with respect to a vertical direction is about from 60 to 90 degrees (less than 90 degrees). In this embodiment, θ2 is 75 degrees, for example.

An upper end surface of the external nozzle 42X (top surface of the cap portion 47) is located slightly below the top surface of the placing portion 54. Therefore, the outer peripheral portion of the substrate 9 does not contact the external nozzle 42X.

In the receiving step of the second embodiment, the outer periphery supporter 50 is lifted up to the upper position as shown in FIG. 9. The outer peripheral portion of the substrate 9 to be processed is placed on the top surface of the placing portion 54 by the forked manipulator 4. At this time, the forked manipulator 4 is inserted in the void portion 55 of one of the longer side support members 51. After the substrate 9 has been placed on the placing portion 54, the forked manipulator 4 is retreated.

Next, in the setting step, the outer periphery supporter 50 is lowered up to the down position as shown in FIG. 6. The substrate 9 is placed on the stage 21. After that, the surface processing step is performed as in the first embodiment.

In the releasing step and the lifting step following the surface processing step, the inert gas is ejected from the suction holes 23. The inert gas g2 from the inert gas source 41 is introduced to the ejection guiding hole 44a of the external nozzle 42X via the supply passage 43. As shown in FIG. 10, the inert gas g2 is guided through the ejection guiding hole 44a to inside the ejection hole 46. The inert gas g2 flows upward along an inner side surface of an inner wall of the ejection hole 46. Flowing upward, the inert gas g2 hits the under surface 46a of the cap portion 47. Then the inert gas g2 is redirected to a direction toward the stage 21 (right in FIG. 10). The inert gas g2 flows obliquely upward along the under surface 46a of the cap portion 47 and spreads in a sector shape. As a result, an ejection flow of the inert gas g2 forms a plane gas flow that flows obliquely upward from the ejection portion 45 toward the edge of the longer side of the placing surface 22 and spreads in a sector shape.

Subsequently, the outer periphery supporter 50 is lifted. Separation of the substrate 9 from the placing surface 22 can be helped by the inert gas 2g in a similar manner as in the first embodiment. Moreover, the outer peripheral portion of the substrate 9 is contacted with the placing portion 54 made of conductive plastics. Therefore, even if peeling electrification occurs in the substrate 9, the electrostatic charge can be discharged through the placing portion 54. The electrostatic charge due to the peeling electrification can be removed. Therefore, the substrate 9 can be separated from the placing surface 22 more easily. Since the placing portion 54 is made of plastics, generation of particles by the contact with the substrate 9 can be prevented or restrained.

The external nozzle 42 is lifted together with the outer periphery supporter 50. The inert gas g2 continues to be ejected from the external nozzles 42 even after the substrate 9 has been completely separated from the stage 21. Therefore, the inert gas g2 continues to contact with the under surface of the substrate 9. Gas pressure of the inert gas g2 prevents a central portion of the substrate 9 from bending downward.

After that, the removing step is performed. Then the steps mentioned above are repeated for another substrate 9 as in the first embodiment.

In the second embodiment, the first up/down mechanism 30 serves also as a second up/down mechanism 80 of the third embodiment to be described later.

### Third Embodiment

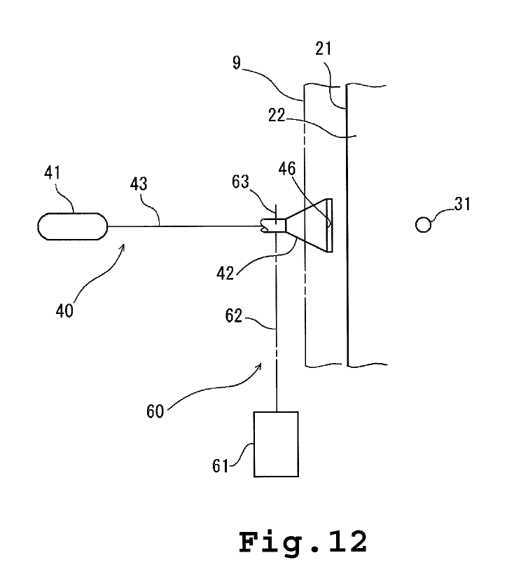

As shown in FIG. 12, the angle adjustment mechanism 60 is connected to the external nozzle 42 in the third embodiment. The angle adjustment mechanism 60 includes a rotation drive power source 61 composed of a stepping motor, etc. and a transmission part 62 composed of a gear train, etc., connecting a drive shaft of the drive power source 61 and the external nozzle 42. The external nozzle 42 is rotated by the angle adjustment mechanism 60 about an axis 63 parallel to the edge of the longer side of the placing surface 22.

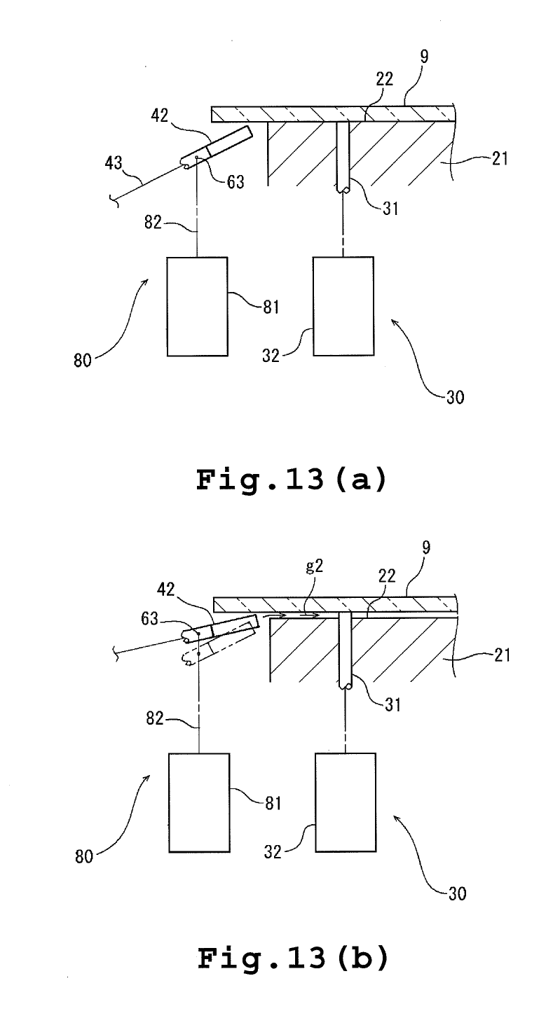

As shown in FIG. 13(a), the external nozzle 42 is further connected to the second up/down mechanism 80. The up/down mechanism 80 includes an up/down drive power source 81 composed of a hydraulic or an electric actuator, etc. and a transmission part 82 composed of an extensible rod, etc., connecting the up/down drive power source 81 and the nozzle 42. As shown in FIG. 13 (b), the external nozzle 42 is lifted and lowered by the up/down mechanism 80. A common drive power source may be used as both the up/down drive power source 81 and the up/down drive power source 32.

The angle adjustment mechanism 60 and the up/down mechanism 80 are driven in synchronization with the up/down mechanism 30. This causes the external nozzle 42 to be lifted and lowered while being rotated in interlocked relation with the lifting and lowering of the substrate 9. To be more specific, while the up/down pins 31 are lifted from the down position to the up position, the external nozzles 42 are lifted in unison with the up/down pins 31, with the external nozzles 42 being rotated in a direction in which an inclination of the external nozzles 42 with respect to a horizontal direction is reduced. This allows the inert gas g2 from the external nozzles 42 to be surely introduced between the substrate 9 and the placing surface 22. Therefore, the substrate 9 can be surely separated from the placing surface 22.

After the substrate 9 has been separated upward from the placing surface 22 to some degree, the external nozzles 42 may be lifted in unison with the up/down pins 31, and an inclination angle of the external nozzles 42 may be maintained at a constant angle. At this time, it is preferable that the inert gas g2 is continuously ejected from the external nozzles 42. This can restrain or prevent the substrate 9 from being bent. Difference in stiffness of the substrate 9 and difference in degree of bending of the substrate 9 due to heat stress in the previous steps can be coped with by adjusting the inclination angle of the external nozzles 42. When the up/down pins 31 are lowered from the upper position, the external nozzles 42 may be moved inversely with when the up/down pins 31 are lifted.

The present invention is not limited to the embodiments described above, but various modifications can be made within the spirit or scope of the invention. For example, the number of the external nozzles 42, 42X and disposition distance among the external nozzles 42, 42X can be set as appropriate. Only one external nozzle 42, 42X may be disposed for every edge of the stage 21. The external nozzles 42, 42X may be disposed at edges of shorter sides of the stage 21 in stead of the edges of the longer sides of the stage 21. The external nozzles 42, 42X may be disposed at both of the edges of the shorter sides and the longer sides of the stage 21. The external nozzles 42, 42X may be disposed at only one edge of the stage 21. The external nozzles 42, 42X may be disposed at three edges of the stage 21. The external nozzles 42, 42X may be disposed at four edges of the stage 21.

The substrate to be surface processed is not limited to those made of glass, but may be a semiconductor wafer, a sheet or a film.

At least two of the embodiments may be combined. For example, the first up/down mechanism 30 may include both of the up/down pins 31 of the first embodiment and the outer periphery supporter 50 of the second embodiment. The external nozzles 42X provided in the outer periphery supporter 50 of the second embodiment may be rotated in interlocked relation with the lifting and lowering of the substrate 9 as in the third embodiment.

In the second embodiment, the external nozzles 42X may be disposed in vertically reverse orientation. The ejection hole 46 may include a lower inner surface. The gas g2 may be blown out toward the lower inner surface from above to form an inclined plane gas flow.

The present invention may be applied to manufacturing of flat panel displays (FPD), for example.

What is claimed is:

1. A stage apparatus for placing a substrate to be surface-processed thereon, comprising:
a stage having a placing surface;
a first up/down mechanism that lowers the substrate from above the placing surface to the placing surface and that lifts the substrate after the surface-processing from the placing surface; and
a nozzle having an ejection hole disposed outside of the placing surface in plan view, the ejection hole opening toward an edge of the placing surface, gas being ejected from the ejection hole toward a gap between the substrate and the placing surface during the lifting of the substrate by the first up/down mechanism.

2. The apparatus according to claim 1 wherein the ejection hole is gradually enlarged toward a distal end thereof in plan view.

3. The apparatus according to claim 1 wherein at least one of an upper inner surface of the ejection hole and a lower inner surface of the ejection hole is inclined upward toward the distal end of the ejection hole from outside of the placing surface in plan view and below the placing surface.

4. The apparatus according to claim 1 wherein the nozzle is angle adjustable about an axis parallel to the edge of the placing surface.

5. The apparatus according to claim 1 wherein the first up/down mechanism includes an outer periphery supporter arranged outside of the placing surface in plan view liftably and lowerably for supporting an outer peripheral portion of the substrate, and wherein the nozzle is disposed in the outer periphery supporter.

6. The apparatus according to claim 1 wherein the apparatus further comprises a second up/down mechanism that lifts and lowers the nozzle in interlocked relation with the lifting and lowering operation of the substrate by the first up/down mechanism.

7. The apparatus according to claim 6 wherein the apparatus further comprises an angle adjustment mechanism that adjusts an angle of the nozzle about the axils parallel to the edge of the placing surface in interlocked relation with the lifting and lowering operation of the nozzle by the second up/down mechanism.

8. The apparatus according to claim 1 wherein the apparatus further comprises first and second nozzle members spaced from each other in a direction along the edge of the placing surface, and wherein each of the first and the second nozzle members constitutes the nozzle.
